(19) United States
(12) Patent Application Publication
(10) Pub. No.: US 2007/0023489 A1
(43) Pub. Date: Feb. 1, 2007

(54) Method of joining components using amorphous brazes and reactive multilayer foil

(76) Inventors: Albert Joseph Swiston JR., Baltimore, MD (US); Timothy P. Weihs, Baltimore, MD (US); Todd Hufnagel, Lutherville, MD (US)

Correspondence Address: POLSTER, LIEDER, WOODRUFF & LUCCHESI, 12412 POWERSCOURT DRIVE SUITE 200, ST. LOUIS, MO, 63131-3615, US

(21) Appl. No.: 11/342,450

(22) Filed: Jan. 30, 2006

Related U.S. Application Data
(63) Continuation-in-part of application No. 10/247,998, filed on Sep. 20, 2002, now Pat. No. 6,991,856.
Application No. 10/247,998 is a continuation-in-part of application No. 09/846,486, filed on May 1, 2001, now Pat. No. 6,736,942.
Application No. 10/247,998 is a continuation-in-part of application No. 09/846,422, filed on May 1, 2001, now abandoned.
Application No. 10/247,998 is a continuation-in-part of application No. 09/846,447, filed on May 1, 2001, now Pat. No. 6,534,194.
(60) Provisional application No. 60/201,292, filed on May 2, 2000.
(60) Provisional application No. 60/362,976, filed on Mar. 8, 2002.

(51) Int. Cl. B23K 1/19

(52) U.S. Cl. 228/262.9; 228/262.1

(57) ABSTRACT

In accordance with the invention, a first body is joined to a second body by joining a first amorphous braze layer to a surface of the first body and joining a second amorphous braze layer to a surface of the second body. A reactive multilayer foil is then disposed between the first and second amorphous braze layers. The layers are pressed together and the foil is ignited. Since the bodies can be joined to the braze layers by processes that do not require a furnace and the braze-coated bodies can be joined by the foil without a furnace, the method can produce strong brazed joints in typical workshop and field environments. Preferably the amorphous braze is a bulk metallic glass.

### CROSS-REFERENCE TO RELATED APPLICATIONS

This application is a continuation-in-part of, and claims priority from, U.S. patent application Ser. No. 10/247,998 filed by T. P. Weihs, et al. on Sept. 20, 2002 which, in turn, is a Continuation-in-part of three U.S. patent applications (hereinafter “the parent applications”): 1) U.S. patent application Ser. No. 09/846,486 filed by T. P. Weihs et al. on May 1, 2000 and entitled “Freestanding Reactive Multilayer Foils” (now U.S. Pat. No. 6,736,942 issued May 18, 2004); 2) U.S. patent application Ser. No. 09/846,422 filed by T. P. Weihs et al. on May 1, 2001 and entitled “Reactive Multilayer Structures For Ease of Processing and Enhanced Ductility”; and 3) U.S. patent application Ser. No. 09/846,447 filed by T. P. Weihs et al. on May 1, 2001 and entitled “Method of Making Reactive Multilayer Foil and Resulting Product.” Each of the three parent applications claims the benefit of United States Provisional Application Ser. No. 60/201,292 filed by T. P. Weihs et al. on May 2, 2000 and entitled “Reactive Multilayer Foils.” The '998 application further claims the benefit of United States Provisional Application Ser. No. 60/362,976 filed by T. P. Weihs et al. on Mar. 8, 2002 and entitled “Freestanding Reactive Multilayer Foils.” The '998 application, the three parent applications, the '942 patent, '292 provisional application and the '976 provisional application are each incorporated herein by reference.

### STATEMENT REGARDING FEDERALLY SPONSORED RESEARCH

This invention was made with Government support under NSF Grant No. DMI-0300396. The government has certain rights in the invention.

### FIELD OF THE INVENTION

This invention relates to a method of joining components using amorphous brazes. The method is particularly useful in joining components by bulk metallic glass brazes. It permits braze joining without a furnace, and thus can be performed in open workshops or in the field.

### BACKGROUND OF THE INVENTION

Methods of joining components, such as bodies of metal, are important in the manufacture and repair of a wide variety of products ranging from miniature electronic circuits (microcircuits) to automobiles, airplanes and ships. Such products are often made or repaired by brazing components together. Upon melting, the braze attaches to both components and serves as an interlayer joining them. Brazes typically have substantially higher melting temperatures than solders and produce much stronger bonds.

While brazing is a preferred joining method for many high strength applications, the high melting temperatures of brazes typically require high temperature specialized furnaces. Such furnaces can be large, expensive and time-consuming to heat and cool. The necessity for such large, specialized furnaces adds considerably to the cost of brazing in manufacture and, for many products, makes field repair impractical. Moreover some brazes, referred to here as amorphous brazes, provide their greatest strength in the amorphous state, but furnaces rarely cool sufficiently fast to avoid crystallizing amorphous brazes. The crystallization of amorphous brazes substantially weakens the resulting joint.

Accordingly there is a need for an improved method of joining components by amorphous brazes that can be used without furnaces and without crystallizing the brazes.

### BRIEF SUMMARY OF THE INVENTION

In accordance with the invention, a first body is joined to a second body by joining a first amorphous braze layer to a surface of the first body and joining a second amorphous braze layer to a surface of the second body. A reactive multilayer foil is then disposed between the first and second amorphous braze layers. The layers are pressed together and the foil is ignited. Since the bodies can be joined to the braze layers by processes that do not require a furnace and the braze-coated bodies can be joined by the foil without a furnace, the method can produce strong brazed joints in typical workshop and field environments. Preferably the amorphous braze is a bulk metallic glass.

The foregoing features and advantages of the invention as well as presently preferred embodiments thereof will become more apparent from the reading of the following description in connection with the accompanying drawings.

### BRIEF DESCRIPTION OF THE SEVERAL VIEWS OF THE DRAWINGS

The nature, advantages and various additional features of the invention will appear more fully upon consideration of the illustrative embodiments now to be described in detail in connection with the accompanying drawings.

In the drawings:

FIG. 1 is a schematic block diagram illustrating the steps involved in joining two bodies in accordance with the invention;

FIGS. 2A, 2B and 2C illustrate various stages of the FIG. 1 process; and,

FIG. 3 illustrates an advantageous multilayer foil for joining the bodies.

It is to be understood that these drawings are for purposes of illustrating the concepts of the invention and are not to scale.

### DESCRIPTION OF THE PREFERRED EMBODIMENT

The following detailed description illustrates the invention by way of example and not by way of limitation. The description enables one skilled in the art to make and use the invention, and describes several embodiments, adaptations, variations, alternatives, and uses of the invention, including what is presently believed to be the best mode of carrying out the invention.

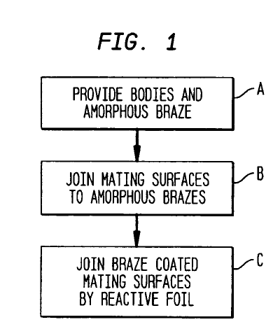

Referring to the drawings, FIG. 1 is a schematic block diagram illustrating an exemplary method of joining two bodies in accordance with the invention. The first step, shown in Block A, is to provide the bodies to be joined and to provide amorphous brazing material. The bodies can be comprised of metal, ceramic, metallic glass, metal alloy, polymer, composite, semiconductor or most other forms of solid material. The bodies should have conforming mating surfaces at which they are to be joined.

The amorphous brazing material is preferably bulk metallic glass, amorphous alloy or alloy that can be amorphized (turned amorphous) by rapid heating and cooling. It can also comprise a quasicrystalline material—a material that is a solid with long range atomic order as demonstrated by an essentially discrete diffraction pattern, but which is not periodic on the atomic scale. Two-phase structures comprising quasicrystalline phases embedded in a metallic glass matrix are particularly advantageous in that they can be stronger than single-phase metallic glass.

The term bulk metallic glass, as used herein, refers to an alloy that is capable of being cast from the liquid state to form an amorphous solid with a minimum dimension of no less than one millimeter. Examples of suitable bulk metallic glasses include Zr_{52.5}Ti₅Cu_{17.9}Ni_{4.6}Al₁₀, Zr₅₇Ti₅Cu₂₀Ni₈Al₁₀, Zr_{41.2}Ti1_{3.8}Cu_{12.5}Ni₁₀Be_{22.5} and Pd₄₀Ni₄₀P₂₀. The amorphous brazing material is advantageously provided in the form of thin sheets, coatings or foil. Typically thicknesses are in the range from˜100 micrometers to ten millimeters.

The next step, shown in Block B, is to join amorphous braze layers or coatings to respective mating surfaces of the bodies. This joining or coating is typically by a non-furnace process that does not require a furnace or a special gas atmosphere, i.e. the process can be carried out at ordinary workshop or field temperatures and environments. A preferred such process is rotational friction welding. Rotational friction welding is described in detail in Kawamura, et al., Welding technologies of bulk metallic glasses, Journal of Non-Crystalline Solids, 2003. 317(2): p. 152-157; Wong, et al., Friction welding of Zr₄₁Ti₁₄Cu_{12.5}Ni₁₀Be_{22.5} bulk metallic glass. Scripta Materialia, 2003. 49(5): p. 393-397; and Kawamura, et al., Superplastic bonding of bulk metallic glasses using friction. Scripta Materialia, 2001. 45(3): p. 279-285. Other non-furnace processes include pulse current welding, as in Arakawa, et al., Method for welding amorphous wound cores, U.S. Pat. No. 4,686,347, 1987 and Kawamura, et al. Spark welding of Zr₅₅Al₁₀Ni₅Cu₃₀ bulk metallic glasses. Scripta Materialia, 2001. 45(2): p. 127-132; electron beam welding, as in Kawamura, et al., Electron Beam Welding of Zr-based Bulk Metallic Glass to Crystalline Zr Metal. Materials Transactions, 2001, 42(12): p. 2649-2651; and explosion welding, as in Kawamura, et al., Development of Welding Technologies in Bulk Metallic Glasses. Materials Science Forum 2002, 386-388: p. 553-558. These non-furnace techniques form strong metallurgical bonds without crystallizing the amorphous braze: see Wong, et al., Friction welding of Zr₄₁Ti₁₄Cu_{12.5}Ni₁₀Be_{22.5} bulk metallic glass, Scripta Materialia, 2003, 49(5): p. 393-397. Rotational friction welding is preferred because it is low cost, well known and widely used.

The third step, illustrated in Block C of FIG. 1, is to join the braze-coated mating surfaces by reactive multilayer foil. This joining involves disposing a reactive multilayer foil between the amorphous braze layers, pressing the layers against the reactive foil and igniting the foil. The foil is preferably a freestanding reactive multilayer foil such as described in detail in U.S. Pat. No. 6,736,942 incorporated herein by reference.

The pressing is typically effected by sandwiching the foil between the braze-coated surfaces and pressing the bodies together against the foil. The pressure can range from 10 MPa to 300 MPa or more. Higher pressure generally causes more extrusion of material from the joint and increases the joint's strength.

Igniting the foil can be effected by match or by electrical spark. The ignited foil undergoes a self-sustaining, self-propagating reaction with large and rapid local heat generation. Typical reactions propagate across the entire foil at velocities greater than 1 ms, reaching temperatures above 1400K and a local heating rate reaching 109 K/s.

The heat of the rapidly reacting foil bonds together the amorphous layers and enhances the bonding between the amorphous layers and the bodies. Moreover the heat quickly dissipates without crystallizing the amorphous braze material.

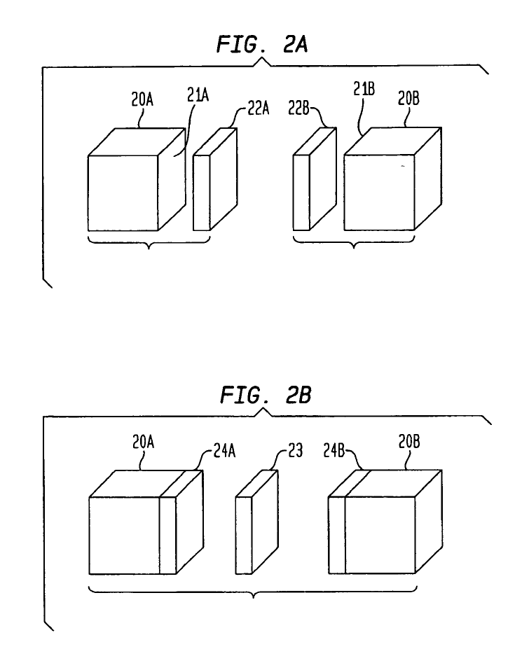

FIGS. 2A, 2B and 2C illustrate the workpieces at various steps in the process of FIG. 1. FIG. 2A shows two components 20A and 20B having respective mating surfaces 21A and 21B being provided with respective coatings or layers of amorphous braze material (22A and 22B). A coating, layer, sheet or thin body of amorphous braze material is joined to each mating surface. The joining is preferably (but not necessarily) by a non-furnace process that does not require a furnace environment.

FIG. 2B shows the braze-coated components being joined by reactive multilayer foil 23. The reactive foil 23 is disposed between the braze-coated mating surfaces 24A and 24B, and the braze-coated components are pressed together against the foil 23. The foil is then ignited as by an electrical spark or match.

FIG. 2C illustrates that the result of the foil ignition (represented by match 25) and pressure (represented by vise 26) is a rapid high temperature reaction through the foil that joins the components 20A and 20B through rapid melting and cooling of the braze coatings or layers 22A and 22B.

If the mating surfaces are coated with braze by one of the non-furnace processes described above, then the entire joining process (joining of braze to the mating surfaces and joining of braze-coated components by reactive foil) can be completed in a non-furnace environment. Elimination of the need for a furnace is highly advantageous for small assembly plants, repair shops, and for repairs in the field.

The brazing of the mating surfaces need not be a non-furnace process for the method to have advantages. For example the mating surfaces of the components can be pre-coated with braze by a supplier using a furnace process and the final assembly coining of the braze pre-coated components by reactive foil) can be accomplished in a non-furnace environment.

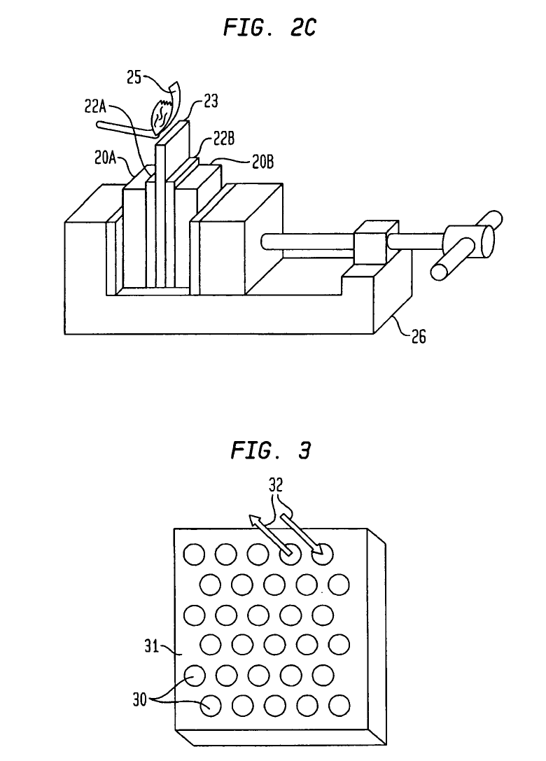

In an advantageous embodiment, the multilayer reactive foil is intentionally designed to provide openings or cracks though which molten braze material can flow. Such openings or cracks permit the braze on one body to directly join to the braze on the other body. Referring to FIG. 3, openings 30 can be formed through the foil 31, preferably in a periodic pattern such as a rectangular array. Any known method may be employed to create the openings. For example, the foil 31 can be sputter deposited on a removable substrate with patterned holes. Or the openings 30 can be physically punched in the foil 31. Preferably the openings 30 have an-effective diameter in the range 10-10,000 micrometers.

In the joining process, the openings 30 allow the brazing material to extrude through the openings (as shown by arrows 32) upon being heated and softened by the exothermic reaction of the foil 31. Upon this extrusion, one layer of brazing material, e.g. 22A, may contact and couple with the brazing layer 22B on the opposite side of the freestanding foil 31. The patterned openings 30 thus permit enhanced bonding of the brazing layers making stronger and more consistent bonds.

Alternatively, cracks through which braze material can flow can be provided by using a reactive foil that shrinks in volume after ignition. Advantageously the foil shrinks in volume by at least 10%. The shrinkage leads to cracks through which the heated brazing material can flow. The cracking can be facilitated by perforating or scoring the foil or by putting the foil under tensile stress.

The invention can now be more clearly understood by consideration of the following specific example.

Zirconium-based bulk metallic glass amorphous braze material was friction-welded to ends of four commercially pure (99.5%) aluminum rods. The four specimens were then reactively joined using Al/Inconel reactive multilayers with a total thickness of 200 micrometers under a joining pressure of 100 MPa. The two resulting Al-Al joints with complementary metallic glass layers were tension tested to failure at stresses of 46 MPa and 53 MPa. The samples used had been significantly bent before joining, such that the tensile forces applied during testing were not axial. Thus, higher failure stresses would be expected in straight samples.

It will be understood that numerous and varied other arrangements can be made by those skilled in the art without departing from the spirit and scope of the invention.

1. A method of joining bodies of material using amorphous brazes comprising the steps of:
providing first and second bodies of material having respective joining surfaces;
bonding said joining surface of said first body and said joining surface of said second body to respective layers or coatings of amorphous braze material;
disposing a reactive multilayer foil between said layers or coatings of amorphous braze material;
pressing said layers against said foil; and
igniting said foil.

2. The method of claim 1 wherein said joining surfaces of said first and second bodies are bonded to said respective layers or coatings of amorphous braze material within a furnace.

3. The method of claim 1 wherein said joining surfaces of said first and second bodies are bonded to said respective layers or coatings of amorphous braze material without a furnace.

4. The method of claim 3 wherein said joining surfaces are bonded to said respective layers or coatings of amorphous braze material by a process selected from a group consisting of rotational friction welding, pulse current welding, electron beam welding, and explosion welding.

5. The method of claim 3 wherein said joining surfaces are bonded to said respective layers or coatings of amorphous braze material by rotational friction welding.

6. The method of claim 1 wherein at least one of said first and second bodies of material comprises a material selected from the group consisting of metal, ceramic, metallic glass, metal alloy, polymer, composite, and semiconductor.

7. The method of claim 1 wherein said amorphous braze material comprises bulk metallic glass.

8. The method of claim 1 wherein said amorphous braze material comprises quasicrystalline material.

9. The method of claim 1 wherein said amorphous braze material comprises a two-phase structure comprising quasicrystalline phases embedded in a metallic glass matrix.

10. The method of claim 1 wherein said amorphous braze material comprises a bulk metallic glass selected from a group consisting of Zr_{52.5}Ti₅Cu_{17.9}Ni_{4.6}Al₁₀, Zr₅₇Ti₅Cu₂₀Ni₈Al₁₀, Zr_{41.2}Ti_{13.8}Cu_{12.5}Ni₁₀Be_{22.5} and Pd₄₀Ni₄₀P₂₀.

11. The method of claim 1 wherein said amorphous braze comprises a layer or coating having a thickness in the range of about 100 micrometers to ten millimeters.

12. The method of claim 1 wherein said reactive multilayer foil includes openings or cracks to permit a flow of amorphous braze from one side of said foil into contact with amorphous braze from an opposite side of said foil.
